(19) United States
(12) Patent Application Publication
(10) Pub. No.: US 2013/0334313 A1
(43) Pub. Date: Dec. 19, 2013

(54) System and method for encoding and extending data limit of barcode symbologies

(71) Applicant: HCL Technologies Limited, Chennai (IN)

(72) Inventor: Bala Aravind Ganesan, Chennai (IN)

(21) Appl. No.: 13/914,812

(22) Filed: Jun. 11, 2013

(30) Foreign Application Priority Data
Jun. 13, 2012 (IN) 2363/CHE/2012

(51) Int. Cl. G06K 19/06; G06K 7/10

(52) U.S. Cl. CPC G06K 19/0614; G06K 7/10821
USPC 235/462.04; 235/494

(57) ABSTRACT

The method and system for extending data limit of a mono-colored barcode is disclosed. The method divides the data into data chunks and assigns a unique color value to individual data chunks. Further the method encodes the data chunks based on the symbology. Then the method multiplexes the encoded data chunks to create a resultant image that contains all the encoded data or barcode. In the decoding process, the barcode reader captures the image and enhances the quality for data extraction. Then the de-multiplexer separates the enhanced image into individual mono colored barcodes. Further, the decoder decodes each individual barcodes into data chunks. Finally, the method merges the data chunks to obtain original barcode data.

### PRIORITY DETAILS

The present application claims priority from Indian Application Number 2363/CHE/2012, filed on 13 Jun. 2012, the disclosure of which is hereby incorporated by reference herein.

### TECHNICAL FIELD

The embodiments herein relate to barcodes and more particularly to extending data limits in Barcodes.

### BACKGROUND OF EMBODIMENT

Barcodes have become a widely accepted method for automatically identifying and tracking objects. A barcode is an optical machine readable representation of data, which shows data about the object to which it attaches. Barcodes can be in any textual or human readable data format that can be converted to machine readable formats. Initially barcodes represented data by varying the width and spacing of parallel lines, and may be referred to as linear or one dimensional (1D). Over a period of time, barcodes evolved into rectangles, dots, hexagons and other geometric patterns in two dimensions (2D).

The mapping between messages and barcodes is called a symbology. The specification of a symbology includes encoding of the single digits or characters of the message as well as the start and stop markers into bars and space, the size of the quiet zone required to be before and after the barcode as well as the computation of a checksum. These symbologies vary by means of appearance, encoding methods and data size.

Linear barcodes can store a very limited number of characters or data. In two dimensional (2D) barcodes, the data limit for storage is comparatively more. The most popular 2D barcode are DataMatrix and QR (Quick Response) code. DataMatrix are characterized by square modules arranged within finder pattern which can store 2300 alpha-numeric characters. DataMatrix is mono colored with a light or contrast background. A QR code is characterized by a square array of modules with a finder pattern located at 3 corners which can stores 4296 alpha-numeric characters and are mono colored with light or contrast background like DataMatrix. QR code is used to store URL's (Unique Resource Locator), V-Cards, tiny image icons and so on. But still this limits storing of a medium sized image, mobile application and the like.

In an existing method, color channels are used to increase the capacity of a barcode image. In this case, the data is divided into data chunks and the color channels are not assigned to each individual data chunks. This makes the barcode identification process cumbersome and since the color channels are not assigned to each individual data chunks the data storage capacity in the barcode is limited.

### SUMMARY

In view of the foregoing, an embodiment herein provides a method for encoding data into a barcode comprises of dividing the data into a plurality of data chunks; assigning a unique color to each of the plurality of data chunks; encoding each of the plurality data chunks based on selected barcode symbology and the unique colour; and combining the plurality of encoded data chunks to form a single barcode.

Also, disclosed herein is a method for decoding a barcode comprising of splitting the barcode to a plurality of individual mono colored barcodes; decoding the plurality of individual mono colored barcodes to obtain a corresponding plurality of data chunks; and merging the plurality of data chunks to form data.

Disclosed herein is an encoder for encoding data into a barcode, the encoder comprising of at least one means configured for dividing the data into a plurality of data chunks; assigning a unique color to each of the plurality of data chunks; encoding each of the plurality data chunks based on selected barcode symbology and the unique colour; and combining the plurality of encoded data chunks to form a single barcode.

Disclosed herein is a decoder for decoding a barcode, the decoder comprising at least one means configured for splitting the barcode to a plurality of individual mono colored barcodes; decoding the plurality of individual mono colored barcodes to obtain a corresponding plurality of data chunks; and merging the plurality of data chunks to form data.

These and other aspects of the embodiments herein will be better appreciated and understood when considered in conjunction with the following description and the accompanying drawings.

### BRIEF DESCRIPTION OF FIGURES

The embodiments herein will be better understood from the following detailed description with reference to the drawings, in which:

FIG. 1 illustrates the block diagram depicting the modules in the barcode encoder as disclosed in the embodiments herein;

FIG. 2 illustrates the block diagram depicting the modules in the barcode decoder as disclosed in the embodiments herein;

FIG. 3 is a flowchart which depicts the process of encoding data into a barcode as disclosed in the embodiments herein; and

FIG. 4 is a flow chart which depicts the process of decoding the barcode for extracting the original data as disclosed in the embodiments herein.

### DETAILED DESCRIPTION OF EMBODIMENT

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

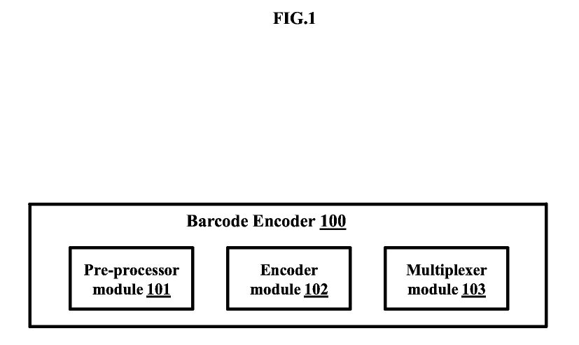

The embodiments herein disclose a system and method for encoding and extending the data size in all applicable mono colored barcode symbologies. The input to the encoder would be a plain text or any binary data which is divided into number of individual data chunks based on the data size limit of the barcode symbology used. Each data chunk is assigned with a unique color value. The colors for each chuck are picked after several permutations and combination of all the colors to be used for encoding and none of two or more combinations result in same color. The method for encoding these color values is also estimated and thereby the barcode is created in the encoding process. Referring now to the drawings, and more particularly to FIGS. 1 through 4, where similar reference characters denote corresponding features consistently throughout the figures, there are shown embodiments.

In one embodiment, the method of extending the data size in barcode is applied to any mono-colored barcode. Also, the disclosed method does not require any barcode special pattern finding algorithm. The method of extending the data limit enables the barcode to store a small mobile app or a low quality audio file.

FIG. 1 illustrates the block diagram depicting the modules in the barcode encoder as disclosed in the embodiments herein. As depicted in the figure, the barcode encoder 100 has three modules such as a pre-processor module 101, an encoder module 102 and a multiplexer module 103. The plain data which is usually in the form of text or binary is fed to the pre-processor module 102. The pre-processor module 101 comprises color assigner and data splitter modules. The data splitter module divides the given plain data into plurality of data chunks and the color assignor module assigns each data chunk with individual color. In one embodiment, the pre-processor module 101 may also choose to insert encoding information which will be used by the decoder. The data chunks with individual colors are fed into the encoder module 102 in which each individual chunk of data is encoded based on the barcode symbology used. In one embodiment, the data chunks are encoded using QR code symbology. The color applied to the generated barcode will be the color that was picked by the color assigner. The resultant will be individual barcode images with different colors. From the encoder module 102 individual encoded data chunks are fed into the multiplexer module 103. The resultant encoded barcode images from the encoder module 102 are then combined to a single image in the multiplexer module 103. In one embodiment, the multiplexer module 103 uses addition or subtraction algorithm to combine the color values of data chunks to form a single image. The resultant image produced in the multiplexer module 103 contains all the encoded data or barcode.

In an embodiment, the QR code symbology is used for encoding data. The QR code which holds several characters are divided into individual data chunks in the pre-processor module 101. Each data chunks are assigned with a color and then fed into the encoder module 102 for encoding. In one embodiment, the individual QR code is assigned with red, blue and green colors. Then the individual encoded data chunks are fed into the multiplexer module 103 where the single barcode image is generated.

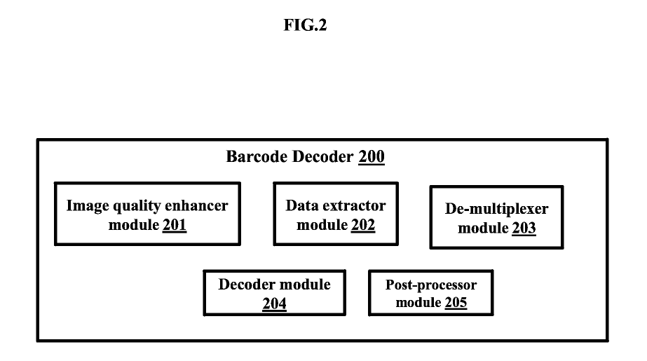

FIG. 2 illustrates the block diagram depicting the modules in the barcode decoder as disclosed in the embodiments herein. As depicted in the figure, the barcode decoder 200 comprises an image quality enhancer module 201, a data extractor module 202, a De-multiplexer module 203, a Decoder module 204 and a post-processor module 205. The multiplexed resultant image in the barcode encoder 100 is decoded back to the original data in the barcode decoder 200. The image captured from the barcode reader will have poor quality due to environmental lighting or noises. The image quality enhancer module 201 enhances the image captured by the barcode reader.

From the quality enhanced image, the actual barcode in the image is identified by the data extractor module 202 or the re-constructor module. The portion of the barcode area is extracted from the completed image are constructed back. In an embodiment the barcode with colors are constructed back.

In one embodiment, the encoded QR code data is extracted by using the color filter to extract individual data in the barcode. For example, if a particular encoded data chunks is assigned with red color, then the red filter is used to extract that particular data chunks.

In the de-multiplexer module 203, the multiplexed data is separated to each individual mono colored barcodes. These individual barcodes is fed in to the decoder module 204. The decoder module 204 decodes each individual barcode based on the barcode symbology used. The resultant output from the decoder module 204 will be the data chunks.

In one embodiment, if the QR code symbology is used for encoding then the decoder module 204 uses the same QR code symbology to decode the data.

Then the individual data chunks from the decoder module 204 are merged to form a single meaning original data. The data merger may use a pre-color order to arrange and merge the data chunks. In one embodiment, the merger may use order specified in the encoding information to merge the data chunks. Finally, the plain data is outputted from the barcode decoder 200.

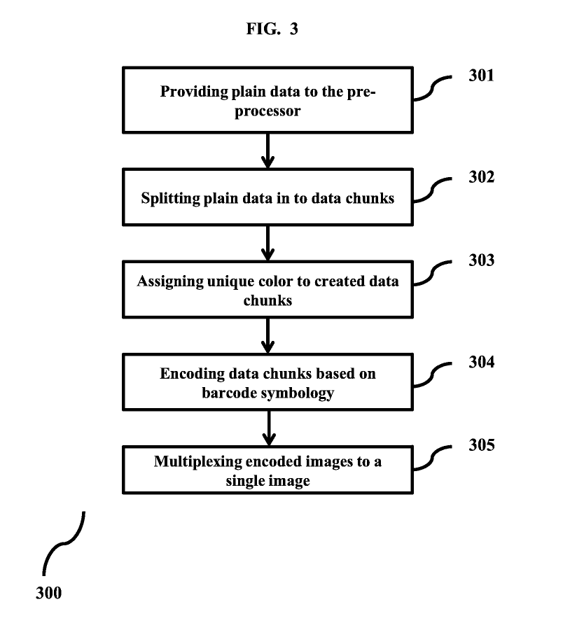

FIG. 3 is a flowchart which depicts the process of encoding data into a barcode as disclosed in the embodiments herein. As depicted in the FIG. 300, the plain data is provided (301) into the pre-processor. The pre-processor divides (302) the data into data chunks. In one embodiment, the size of the data is identified and analyzed for the number of data chunks to be created, thereby determining the size of each data chunk. In an embodiment, size of the each data chunks may or may not have equal size. The data limit of the barcode symbology and type of data are considered for obtaining the data chunk size. Then the created data chunks are assigned (303) with unique color to individual data chunks. Further, the data chunks are encoded (304) based on the barcode symbology. Then the encoded data chunks are multiplexed (305) to a single image.

In one embodiment, if the barcode symbology used is data matrix, then the data in the data matrix are divided into data chunks and assigned with individual color. Then individual data chunks are encoded with data matrix symbology. Further, the individual encoded data chunks are multiplexed to a single image. Multiplexing data chunks involves using simple addition or subtraction of color values algorithms.

In one embodiment, multiplexing implements additive combination of three colors (three barcodes) such as color A, color B and color C. The color values of red, green, blue in these three colors are R=255, G=0, B−=0 in color A, R=0, G=255, B=0 in color B and R=0, G=0, B=255 in color C respectively. By implementing additive algorithm between color A and color B, the color value of red, green and blue that corresponds to color A and color B gets added. In this case, by adding the color values of color A and color B results in R=255, G=255, B=0. Similarly, the additive combination of color B, color C and additive combination of color A and color C may be obtained by adding their corresponding color values.

In another embodiment, multiplexing implements additive combination of four colors (four barcodes) such as color A, color B, color C and color D. The color values of red, green, blue in these four colors are R=10, G=100, B=0 in color A, R=10, G=20, B=100 in color B, R=100, G=0, B=10 in color C and R=0, G=10, B=100 in color D respectively. By implementing additive algorithm between color A and color B, the resultant color values upon addition becomes R=20, G=120, B=100. Several combinations of addition may be used between color A, color B, color C and color D in the multiplexing.

In yet another embodiment, the multiplexing uses custom combination of three colors (three barcodes) such as color A, color B and color C. The color values red, green, blue that corresponds to color A is R=255, G=0, B=0, color B is R=255, G=255, B=0 and color C is R=0, G=O, B=255 respectively. The custom combination may be subtracting color A from color B and adding the resultant color value with color C. By subtracting color value of color A from color B results in the color value (color B-color A) is R=0, G=255, B=0 then adding this color value with the color value of color C will become (color B−color A+color C) R=0, G=255, B=255. Similarly, several custom combinations may be used between color A, color B and color C in multiplexing.

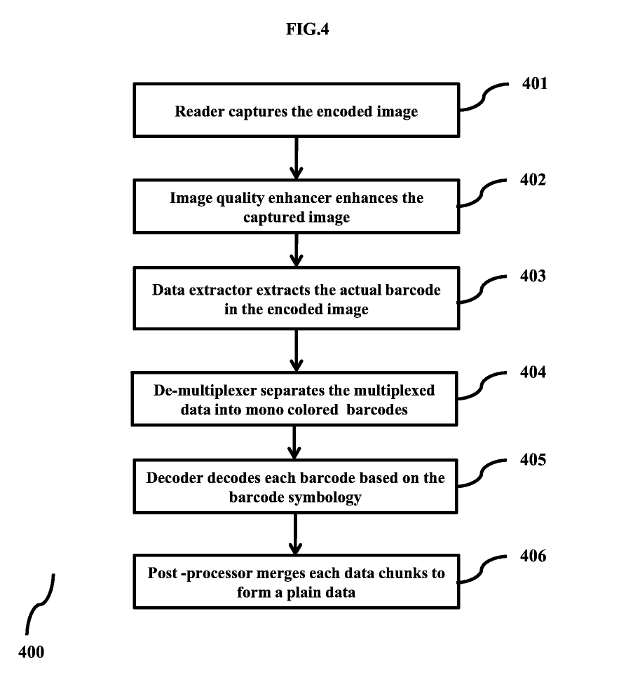

FIG. 4 is a flow chart which depicts the process of decoding the barcode for extracting the original data as disclosed in the embodiments herein. As depicted in the FIG. 400, the barcode reader captures (401) the encoded image. In one embodiment, the barcode reader may be a camera. Then the image quality enhancer enhances (402) the captured image. In one embodiment, the image quality has to be enhanced to the extent that the decoder can extract the colors from the image.

The resultant image from the encoding process cannot be directly fed to the barcode decoder, which usually is unreadable. Once the reader captured image is enhanced for quality, it is then identified for actual barcode in it. Then the data extractor or re-constructor extracts (403) the actual barcode in the encoded image. The quality image with colors is constructed back.

In one embodiment, the barcode is reconstructed and the colors are regenerated back to get the clear noiseless barcode. Once the finder potion of the barcode is found, an empty barcode skeleton is created and divided into number of equal blocks or lines based on the barcode symbology used. Then for each block in the skeleton barcode a color is assigned by comparing the respective block in the scanned barcode image.

Further, the de-multiplexer separates (404) the multiplexed data into mono colored barcodes. The barcode from data extractor or re-constructor is still unreadable to the decoder. The multiplexed data is separated to each individual mono colored barcodes. These individual barcodes are now ready for decoding. The decoder decodes (405) each barcode based on the barcode symbology. The resultant output will be the individual data chunks. Finally, post -processor merges (406) each data chunks to form a plain data.

The embodiments disclosed herein can be implemented through at least one software program running on at least one hardware device and performing network management functions to control the network elements. The network elements shown in FIGS. 1 and 2 include blocks which can be at least one of a hardware device, or a combination of hardware device and software module.

The embodiment disclosed herein specifies a system for extending the data limit in barcode symbology by assigning unique color value to individual data chunks. The mechanism allows dividing the data into data chunks and assigning a unique color to individual data chunks by providing a system thereof. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in e.g. Very high speed integrated circuit Hardware Description Language (VHDL) another programming language, or implemented by one or more VHDL or several software modules being executed on at least one hardware device. The hardware device can be any kind of device which can be programmed including e.g. any kind of computer like a server or a personal computer, or the like, or any combination thereof, e.g. one processor and two FPGAs. The device may also include means which could be e.g. hardware means like e.g. an ASIC, or a combination of hardware and software means, e.g. an ASIC and an FPGA, or at least one microprocessor and at least one memory with software modules located therein. Thus, the means are at least one hardware means and/or at least one software means. The method embodiments described herein could be implemented in pure hardware or partly in hardware and partly in software. The device may also include only software means. Alternatively, the embodiment may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

we claim:

1. A method for encoding data into a barcode comprising of
dividing said data into a plurality of data chunks;
assigning a unique color to each of said plurality of data chunks;
encoding each of said plurality data chunks based on selected barcode symbology and said unique colour; and
combining said plurality of encoded data chunks to form a single barcode.

2. The method, as claimed in claim 1, wherein number of said data chunks depends on at least one of size of said data or size of each of said plurality of data chunks.

3. The method, as claimed in claim 2, wherein size of each of said plurality of said data chunks is predefined.

4. The method, as claimed in claim 1, wherein combining said plurality of encoded data chunks to form a single barcode is performed by at least one of addition of colour values or subtraction of colour values.

5. The method, as claimed in claim 1, wherein combining said plurality of encoded data chunks to form a single barcode is performed by performing compound calculations.

6. A method for decoding a barcode comprising of
splitting said barcode to a plurality of individual mono colored barcodes;
decoding said plurality of individual mono colored barcodes to obtain a corresponding plurality of data chunks; and
merging said plurality of data chunks to form data.

7. The method as in claim 6, wherein said method comprises of
capturing an image of said barcode; and
enhancing quality of said image.

8. The method as in claim 7, wherein said method further comprises of extracting barcode area from said enhanced image.

9. The method as in claim 6, wherein said method comprises of decoding said individual mono colored barcodes based on symbology.

10. An encoder for encoding data into a barcode, said encoder comprising of at least one means configured for
dividing said data into a plurality of data chunks;
assigning a unique color to each of said plurality of data chunks;
encoding each of said plurality data chunks based on selected barcode symbology and said unique colour; and
combining said plurality of encoded data chunks to form a single barcode.

11. The encoder, as claimed in claim 10, wherein said encoder is further configured for combining said plurality of encoded data chunks to form a single barcode by performing at least one of addition of colour values or subtraction of colour values.

12. The encoder, as claimed in claim 10, wherein said encoder is further configured for combining said plurality of encoded data chunks to form a single barcode by performing compound calculations.

13. A decoder for decoding a barcode, said decoder comprising at least one means configured for
splitting said barcode to a plurality of individual mono colored barcodes;
decoding said plurality of individual mono colored barcodes to obtain a corresponding plurality of data chunks; and
merging said plurality of data chunks to form data.

14. The decoder, as in claim 13, wherein said decoder is further configured for
capturing an image of said barcode; and
enhancing quality of said image.

15. The decoder, as in claim 13, wherein said decoder is further configured for extracting barcode area from said enhanced image.

16. The decoder, as in claim 13, wherein said decoder is further configured for decoding said individual mono colored barcodes based on symbology.
